(19) United States
(12) Patent Application Publication
(10) Pub. No.: US 2020/0242853 A1
(43) Pub. Date: Jul. 30, 2020

(54) System and Method For Estimating Vehicle Body Damage

(71) Applicant: Hunter Engineering Company, Bridgeton, MO (US)

(72) Inventors: Alan Hagerty, O'Fallon, MO (US); Nicholas J. Colarelli, III, Frontenac, MO (US)

(21) Appl. No.: 16/745,663

(22) Filed: Jan. 17, 2020

Related U.S. Application Data
(60) Provisional application No. 62/796,264, filed on Jan. 24, 2019.

(51) Int. Cl. G07C 5/00; G06Q 10/00; G01N 21/88; G07C 5/08; G06T 7/00

(52) U.S. Cl. CPC G07C 5/006; G06Q 10/20; G01N 21/8851; G06T 2207/30156; G07C 5/0808; G06T 7/0004; G01N 2021/8887; G07C 5/008

(57) ABSTRACT

A system and method of vehicle inspection in which sequences of images of vehicle body surfaces are acquired as a vehicle passes through fields of view associated with imaging sensors disposed on each lateral side of an inspection lane. The acquired sequences of images are evaluated through a software-configured processing system, either automatically or by an operator, to identify the presence of visible damage on the vehicle body surfaces. If visible damage is present, and an election is made to forward the vehicle and/or customer information to a collision repair facility for follow-up, one or more images from the sequences are selected, and communicated together with vehicle and/or customer identifying information from the processing system to the collision repair facility.

### CROSS-REFERENCE TO RELATED APPLICATIONS

The present application is related to, and claims priority from, co-pending U.S. Provisional Patent Application Ser. No. 62/796,264 filed on Jan. 24, 2019, which is herein incorporated by reference.

### STATEMENT REGARDING FEDERALLY SPONSORED RESEARCH

Not Applicable.

### BACKGROUND OF THE INVENTION

The present invention is related generally to methods and systems for inspection of vehicles in motion, and in particular, to a method and system for utilizing sequences of images of a moving vehicle undergoing an inspection, acquired from a set of cameras disposed on opposite sides of an inspection lane, to evaluate vehicle body damage and to facilitate a conveyance of vehicle related information to an associated collision repair facility.

Traditionally, when a vehicle is brought into a repair facility for service, an employee of the repair facility will conduct a walk-around visual inspection of the parked vehicle, noting and/or photographing any pre-existing damage, such as dents, scrapes, or missing pieces on the vehicle's exterior surface. Similar procedures are often implemented prior to a customer taking possession of a rental vehicle from a rental service. These walk-around inspections serve two purposes, first, to establish a record of the vehicle's current condition, and second, to identify additional repair services available to the customer. If equipped with suitable inspection equipment, a repair facility may conduct inspections of the vehicle's wheel alignment, tire tread depth, battery condition, etc. at the time of the walk-around visual inspection.

Improvements in vehicle inspection equipment, such as shown in U.S. Pat. Nos. 9,046,446 B1, 9,779,560 B1 and 9,779,561 B1, and U.S. Patent Application Publication No. U.S. 2018/0293817 A1, each assigned to Hunter Engineering Company of St. Louis, Mo. and each herein incorporated by reference, automate various aspects of a vehicle inspection process, and enable inspection of vehicles in motion as they pass through a vehicle inspection lane. Imaging sensors included within automated vehicle inspection systems capture and record images of the vehicles undergoing inspection, creating a record of the vehicle's condition at the time of inspection. The imaging sensors further enable automatic identification of the moving vehicle using license plate recognition procedures, such as shown in U.S. Pat. No. 9,990,376 B2 assigned to Hunter Engineering Company and herein incorporated by reference. The resulting images, inspection results, and vehicle identifying data are communicated to, and stored in, an accessible database. The acquired images of the vehicle may be recalled at a future date in response to questions regarding the condition of the vehicle upon arrival at the repair facility, ensuring that repair facilities are only held liable for cosmetic or other damage if such damage occurred after arrival of the vehicle.

It would be advantageous to enable the images of a vehicle in motion acquired as the vehicle passes through an automated inspection lane to be efficiently utilized in a revenue generating capacity in addition to serving as protection for the repair facility against claims for pre-existing damages to the vehicle.

### BRIEF SUMMARY OF THE INVENTION

Briefly stated, a drive-through vehicle inspection system of the present disclosure incorporates a set of imaging sensors to acquire sequences of images of moving vehicles passing through an inspection lane. At least one imaging sensor is disposed on each lateral side of the inspection lane, and is oriented with a field of view non-orthogonal to an intended vehicle travel direction within the inspection lane. Sequences of images captured by the imaging sensors establish a record of the visible vehicle body surfaces at a various positions within the inspection lane. Preferably, the imaging sensors have an image acquisition rate sufficient to ensure that sequential images within each vehicle sequence capture overlapping portions of the visible vehicle body surfaces as the vehicle passes through the sensor's field of view. The acquired sequences of images are communicated to a processing system configured with software instructions to store the images and to provide an operator with a reviewable display of the images within a graphical user interface. The reviewable display of the images includes interactive icons to enable the operator to selectively review individual images, crop and/or enlarge images, and annotate images. An interactive icon within the graphical user interface enables the operator to initiate a communication of selected images, together with customer identifying data, to a collision repair facility.

In an alternate embodiment of the drive-through vehicle inspection system, the processing system is configured with a set of software instructions to evaluate identifiable vehicle body surfaces contained within an acquired sequence of images to identify visible damage. The processing system is further configured with software instructions to respond to an identification of damages vehicle body surfaces by notifying an operator and/or generating a message for conveyance to a collision repair facility indicating a potential vehicle repair opportunity.

In a method of the present disclosure, a vehicle drives through an inspection lane while imaging sensors disposed on each lateral side of the inspection lane acquire sequences of vehicle body surface images. The acquired image sequences are evaluated, either automatically or by an operator, to detect visible damage present on the vehicle body surfaces. Alternatively, the vehicle is directly observed by the operator, and images illustrating any damage visibly observed are manually selected. If visible damage is present, and an election is made to forward the vehicle and/or customer information to a collision repair facility for follow-up, one or more images from the sequences are selected, and communicated together with vehicle and/or customer identifying information to the collision repair facility.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a perspective view of a multi-camera exemplary sensor unit for use in a vehicle inspection lane;

FIG. 2 is a plan view of an exemplary vehicle inspection lane, including two of the multi-camera sensor units of FIG. 1, illustrating opposing and overlapping camera fields of view for capturing images of a vehicle moving through the inspection lane;

FIG. 3 is an exemplary screen capture from a system of the present disclosure, illustrating vehicle identifying information, a vehicle body image scrollbar, and a selected vehicle body with accompanying image manipulation icons; and

FIG. 4 is a flow chart illustrating a process of the present disclosure for receiving a vehicle, evaluating acquired images, and optionally conveying images and data to a Collision Repair Center.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

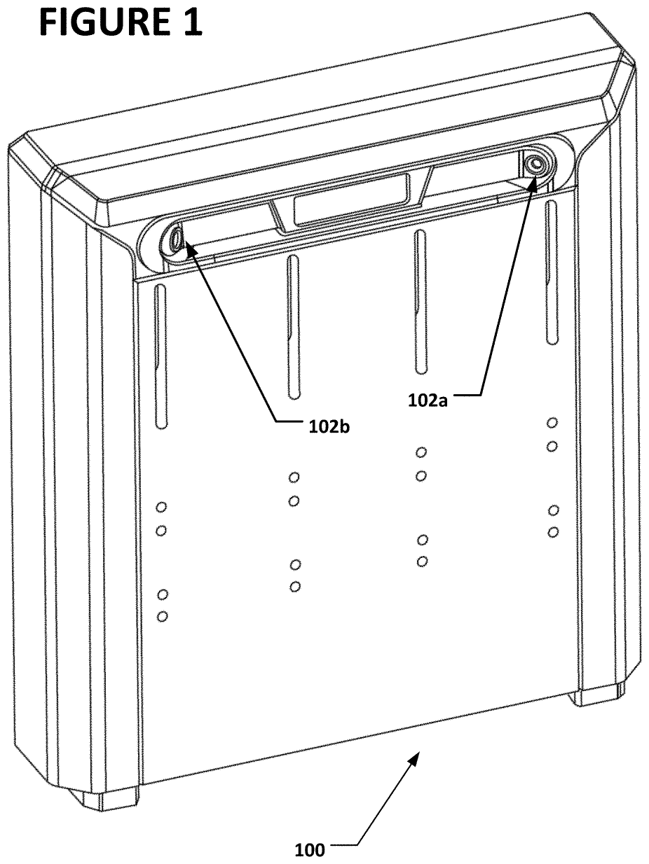

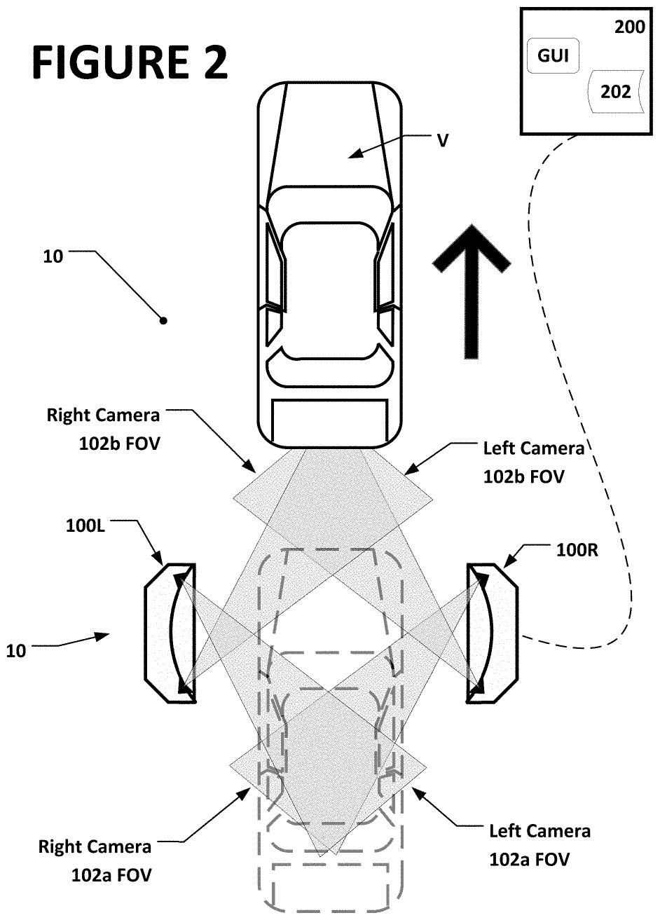

Turning to the figures, and to FIGS. 1 and 2 in particular, a drive-through vehicle inspection system 10 is shown in which a pair of sensor units 100R, 100L (FIG. 1) are disposed on opposite lateral sides of an inspection lane 12 (FIG. 2) through which a vehicle V is driven. Each sensor unit 100 includes at least one imaging sensor 102 configured to acquire a sequence of images encompassing a fixed field of view as a vehicle passes through the inspection lane. The fields of view for each imaging sensor 102 are oriented non-orthogonal to the intended travel direction of vehicles V passing through the inspection lane 12, as best seen in FIG. 2. Utilizing non-orthogonal fields of view enables each imaging sensor 102 to capture a sequence of images either as the vehicle V approaches and passes through the inspection lane 12, or as the vehicle V passes through and departs from the vehicle inspection lane 12. A sequence of images from an individual imaging sensor 102 includes images of body surfaces along one lateral side of the vehicle V as well as images of either the front or rear body surfaces. Utilizing two imaging sensors 102a, 102b within each sensor unit 100, one with a field of view oriented towards a vehicle approach to the inspection lane (102a) and one with a field of view oriented toward a vehicle V exit from the inspection lane (102b) as shown in FIG. 2 enables the acquired sequences of images associated with a passing vehicle V to fully capture the front, rear, and side body surfaces.

Each imaging sensor 102 is configured for image acquisition rates sufficient to capture multiple overlapping images of the vehicle body surfaces as the vehicle V passes through the inspection lane 12 within a recommended speed range of 1-15 mph. With overlapping images, sequential images from a single imaging sensor 102 in a sequence will each include at least a portion of the same body surface, albeit at a different position within the field of view. Capturing multiple images of the same body surface at different positions within a fixed field of view allows for variations in illumination, reflections, and proximity, which can enhance the visibility of damage on the body surfaces.

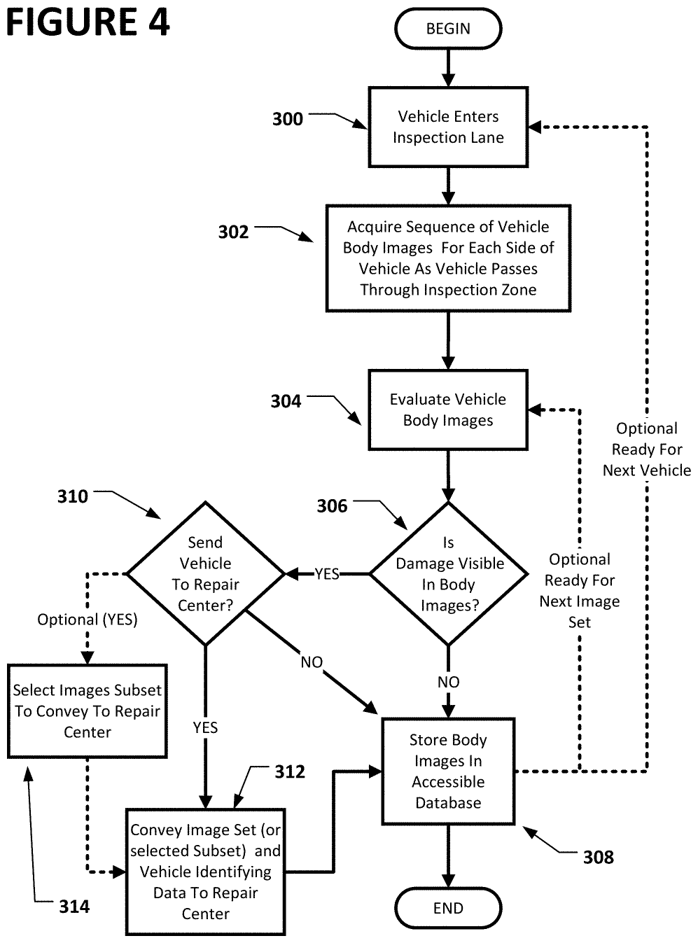

Turning to FIG. 4, an exemplary evaluation process begins with the vehicle V entering the inspection lane 12, as shown at Box 300. Images are acquired (Box 302) and communicated from the imaging sensors 102 to a processing system 200 associated with the sensor units 100. The processing system 200, configured with suitable software for receiving the acquired images, may be a local processing system, or may be a remote processing system, such as a cloud-based system as shown in U.S. Patent Application Publication 2018/0293817 A1. Independent of further processing or image analysis, the acquired images associated in a data record with vehicle and/or customer identifying information, such as, but not limited to, license plate data, vehicle identification numbers, customer records, geolocation data, and time-stamp data.

The acquired sequences of images for a vehicle V passing through the inspection lane 12 are evaluated (Box 304), either automatically at the processing system 200 by a set of software instructions using an image evaluation process such as shown in U.S. Patent Application Publication No. 2014/0316825 A1 to Audatex North America, Inc., or manually by an operator, do determine if damage is visible on the vehicle body (Box 306). If no vehicle body damage is identified by the evaluation process, the data record is stored (Box 308) for future retrieval in an accessible data store 202, and the process repeated for the next vehicle. If vehicle body damage is identified by the evaluation process, a further evaluation of the need to forward the information to a vehicle collision repair shop is made (Box 310). Minor damage, such as a scuff or scratch, may not be sufficient to necessitate the need for collision repair shop involvement, in which case the data record is stored (Box 308), and the process repeated for the next vehicle. In the event that the vehicle body damage is sufficient to justify forwarding the information to a vehicle collision repair shop, or as a default condition, the data record is communicated (Box 312) to the vehicle repair center, together with relevant customer (vehicle owner) contact information, prior to storage (Box 308) and resetting of the system for the next vehicle. Optionally, an operator may visually inspect the vehicle V, or review the set of images to select (Box 314) a specific subset of images in which the observed damage is most clearly visible for communication to the vehicle collision repair center (Box 312) in a data record.

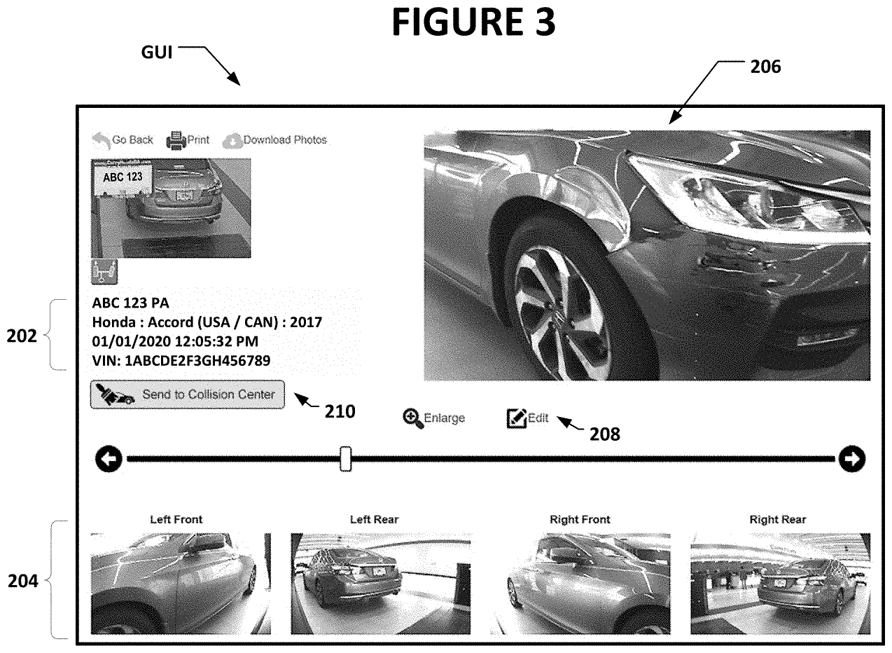

To facilitate operator review of the acquired images for each vehicle, the processing system 200 may be configured with software instructions to display the sequences of images to an operator for manual evaluation within the graphical user interface (GUI), such as shown in FIG. 3. The GUI may be presented on a local computer system within the repair facility, a tablet PC, a mobile phone software application, or any other suitable operator interface in communication with the processing system 200. All of, or just a subset of, the acquired images for a specific vehicle V may be presented to the operator within the GUI, together with a collection of vehicle identifying data 202, such as, but not limited to, an image of a license plate on the vehicle, license plate data, vehicle identification number data, timestamp data, and vehicle diagnostic or inspection results. The GUI is configured to include a region 204 in which sequences of images associated with the identified vehicle V can be reviewed, such as an image carousel, a scrolling image bar, a film-strip style display, or an image grid. Any conventional method for displaying a set of images within a GUI may be utilized. Further included within the GUI is a region 206 in which an individual image, selected from the set of available images, is displayed. Associated with the individual image are one or more icons or interactive elements 208 within the GUI for providing image panning, zoom controls, image editing, and image annotating functionality, enabling an operator to closely review the selected image to identify the presence of damage on a vehicle body surface, annotate the image to highlight or direct attention to the identified damage, and to save the selected and/or annotated image. An additional communication icon, button or other interactive element 210 within the GUI, initiates a procedure such as shown in FIG. 4 for communicating a data record comprising one or more selected and/or annotated images and associated vehicle and/or customer identifying information to a collision repair center.

Upon either an automatic or manual identification of a presence of damage to a body surface within one or more images associated with a vehicle V, the operator may initiate communication of the information to a collision repair center by selection of the communication icon 210. Selection of the communication icon 210 initiates a set of software instructions to collect and package relevant data record for conveyance to a remote processing system (not shown) associated with the vehicle collision repair center. For example, following selection of the communication icon 210, a pop-up window or other suitable interface is presented to the operator in the GUI. Within the pop-up window are various data entry fields within which the operator can provide necessary information for the collision repair center to use for contacting the vehicle owner. A “submit” or “send” interactive icon may be included within the pop-up window, providing a signal to the processing system 200 to package all of the information from the various data entry fields with the vehicle identifying information together with all of, or a selected subset of, the vehicle images into a message for conveyance to the vehicle collision repair center. Once the packaged information has been sent, the processing system 200 is configured to confirm the transmission, such as through a confirmation pop-up window within the GUI, informing the operator that the process is complete.

It will be understood by those of ordinary skill in the art that the image review process and the passing of the vehicle V through the inspection lane 12 may be separated by a significant period of time, and need not occur in close temporal proximity to each other. For example, a designated employee at a repair shop may reserve time during slow periods of a day to review images of vehicles V which arrived at the repair shop during an early morning check-in rush, rather than trying to complete a review of each individual vehicle V upon arrival, thereby ensuring a smooth flow of traffic through the inspection lane 12.

Alternatively, the image review may be carried out by an operator at a location which is remote from the vehicle inspection lane 12. For example, the vehicle inspection lane 12 may be located adjacent to a car-wash or other high-traffic facility, and in networked communication with a repair center at a separate location across town. Vehicles V passing through the inspection lane 12 are identified, and inspection results are conveyed to the driver/owner via e-mail or text message, together with advertising or other marketing materials in an effort to solicit vehicle repair business. An operator at the repair center may review the images, and communicate relevant information for vehicles having identified damage to the collision repair facility for further follow-up with the identified vehicle owner.

The present disclosure can be embodied in-part in the form of computer-implemented processes and apparatuses for practicing those processes. The present disclosure can also be embodied in-part in the form of computer program code containing instructions embodied in tangible media, or another computer readable non-transitory storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a non-transitory storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A vehicle inspection system associated with a vehicle inspection lane through which a vehicle is driven, comprising:
a first sensor unit disposed adjacent a first lateral side of said vehicle inspection lane, said first sensor unit including at least one associated first-side imaging sensor having a fixed field of view oriented towards said inspection lane;
a second sensor unit disposed adjacent a second lateral side of said vehicle inspection lane, opposite said first sensor unit, said second sensor unit including at least one associated second-side imaging sensor having a fixed field of view oriented towards said inspection lane;
a processing system in communication with each of said first and second sensor units to receive images acquired by each of said associated first- and second-side imaging sensors;
wherein said processing system is configured with software instructions to convey one or more images from a set of received images of a vehicle passing through said inspection lane, together with associated vehicle and/or customer identifying information, to a collision repair facility processing system.

2. The vehicle inspection system of claim 1 wherein said one or more conveyed images capture visible body damage on said passing vehicle.

3. The vehicle inspection system of claim 1 wherein each of said associated first- and second-side imaging sensors is configured to acquire a sequence of images of the vehicle passing through the vehicle inspection lane.

4. The vehicle inspection system of claim 3 wherein each of said associated first- and second-side imaging sensors is further configured with an image acquisition rate selected to ensure that sequential images within each sequence of images each capture a common portion of a body surface of the passing vehicle at a different location within the fixed field of view.

5. The vehicle inspection system of claim 3 wherein each sequence of images includes at least one image of a vehicle body side surface, and at least one image of either a vehicle body front surface or a vehicle body rear surface.

6. The vehicle inspection system of claim 1 further including a display device in operative communication with said processing system for presenting a graphical user interface to an operator; and
wherein said processing system is configured with software instructions to present, within said graphical user interface, a vehicle review presentation for a vehicle having passed through said inspection lane, said vehicle review presentation including at least a) identifying information for said vehicle, b) an interactive element to facilitate selection and review of images associated with said vehicle, and c) an interactive element to initiate a communication of at least one associated image and said vehicle identifying information to said collision repair facility processing system.

7. The vehicle inspection system of claim 6 wherein said vehicle review presentation within said graphical user interface further includes at least one interactive element for enabling editing and/or annotation of a selected image prior to communication to said collision repair facility processing system.

8. The vehicle inspection system of claim 6 in which said interactive element to initiate said communication is configured to respond to an operator input by presenting one or more additional data entry fields within said graphical user interface, whereby data entered within said additional data entry fields is communicated to said collision repair facility processing system together with said at least one associated image and said vehicle identifying information.

9. The vehicle inspection system of claim 1 wherein said first- and second-side imaging sensor fields of view are oriented non-orthogonal to an intended travel direction of a vehicle through said inspection lane.

10. A vehicle inspection method, comprising:
acquiring at least one sequence of images associated with body surfaces on each lateral side of a vehicle passing through an inspection lane;
subsequently evaluating at least one image in said acquired sequences of images to detect visible damage present on an imaged body surface of said vehicle;
responsive to detection of visible damage present on a body surface of said vehicle, communicating said at least one image together with vehicle identifying data and/or owner identifying data to a collision repair facility.

11. The method of claim 10 wherein said at least one sequence of images is acquired from an imaging sensor having a field of view oriented non-orthogonally to an intended direction of travel for vehicles passing through said inspection lane.

12. The method of either claim 10 wherein subsequently evaluating said at least one image includes presenting said at least one image to an operator for manual review within a graphical user interface.

13. The method of either claim 10 wherein subsequently evaluating said at least one image includes comparing vehicle body surfaces present within said at least one image with a vehicle body surface reference model to detect deviations indicative of damage.

14. A vehicle condition reporting method, comprising:
acquiring a set of images associated with body surfaces on a vehicle passing through an inspection lane, said plurality of images including at least one image of a front body surface, at least one image of a rear body surface, and at least one image of each lateral side body surface;
generating a data record for said vehicle, said data record including said set of images and at least one vehicle identifier; and
reviewing said data record to detect, within said set of images, visible damage to a body surface of said vehicle;
responsive to a detection of visible damage present on a body surface of said vehicle, communicating at least one selected image from said set of images, together with said at least one vehicle identifier to a processing system associated with a vehicle collision repair facility.

15. The method of claim 14 wherein reviewing said data record includes presenting images from said data record to an operator within a graphical user interface; and
wherein communication to said vehicle collision repair facility is initiated by said operator following observation of visible damage to a body surface within at least one of said presented images.

16. The method of claim 15 wherein said at least one selected image is selected by said operator within said graphical user interface prior to said communication.

17. The method of claim 14 further including generating a damage repair estimate for said vehicle at said vehicle collision repair facility using said communicated at least one selected image.
